(19) United States
(12) Patent Application Publication
(10) Pub. No.: US 2024/0256318 A1
(43) Pub. Date: Aug. 1, 2024

(54) SYSTEM AND METHOD FOR MANAGING PODS HOSTED BY VIRTUAL MACHINES

(71) Applicant: Dell Products L.P., Round Rock, TX (US)

(72) Inventors: BALASUBRAMANIAN CHANDRASEKARAN, Austin, TX (US); DHARMESH M. PATEL, Round Rock, TX (US)

(21) Appl. No.: 18/160,492

(22) Filed: Jan. 27, 2023

(51) Int. Cl. G06F 9/455

(52) U.S. Cl. CPC G06F 9/45558; G06F 2009/45562; G06F 2009/4557

(57) ABSTRACT

Methods and systems for managing pods hosted by virtual machines are disclosed. To manage the pods, the activity of virtual machines hosting the pods may be monitored to identify when the virtual machines may be decommissioned. When an identification is made, actions may be performed to manage the pods through the decommissioning. The actions may include gracefully terminating operation of the pod, preventing new pods from being deployed to the virtual machines, and attempting to abort the decommissioning.

### FIELD

Embodiments disclosed herein relate generally to operation management. More particularly, embodiments disclosed herein relate to systems and methods to manage coordination between pods and virtual machines.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a diagram illustrating data flows, processes, and other aspects of a system in accordance with an embodiment.

FIGS. 3A-3B show flow diagrams illustrating a method of providing computer implemented services using pods and virtual machines in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer implemented services using pods hosted by virtual machines. To provide the computer implemented services, instances of the pods and virtual machines may be dynamically instantiated and decommissioned over time.

To manage the instantiation and decommissioning, an orchestrator may identify when decommissioning will occur. The orchestrator may identify why the decommissioning is occurring, and may manage entities impacted by the decommission based on the reasons.

For example, when the decommissioning is for unplanned reasons, the orchestrator may automatically initiate graceful termination of impacted entities, and prevent additional entities from being instantiated that will be impacted.

When the decommissioning is for load balancing purposes, the orchestrator may automatically attempt to reduce resource consumption by the impacted entities. Doing so may reduce resource consumption thereby rebalancing the load.

If the rebalancing is successful, then the decommissioning may be automatically aborted by the entity that initiated the decommissioning. Consequently, the impacted entity may continue to operate without needing to plan for imminent cessation of operation.

For example, when a virtual machine that hosts a pod is decommissioned, the hosted pod may need to take certain actions to prepare for cessation of its operation. Otherwise, the pods may be negatively impacted, data may be lost, processes may not be completed, and/or other types of undesired outcomes may occur.

By managing decommissioning of pods and virtual machines in this manner, a system in accordance with embodiments disclosed herein may be more likely to provide desired computer implemented services. By proactively identifying and preparing for decommissioning of virtual machines and pods, the computing implemented services may be less likely to be impacted by the decommissioning.

Accordingly, embodiments disclosed here may address, among other problems, the technical problem of entity management in distributed systems. By automatically identifying decommissioning that may impact a variety of entities, the disclosed system may automatically coordinate responses to the decommissioning even though the entities initiating the decommissioning may not coordinate with one another. Accordingly, a data processing system in accordance with embodiments disclosed herein may more efficiently marshal limited computing resources by reducing the likelihood of interruptions in providing computer implemented services.

In an embodiment, a method for providing computer implemented services using pods hosted by virtual machines is provided. The method may include making an identification of a decommissioning of a virtual machine of the virtual machines, the virtual machine being hosted by a data processing system; based on the identification: identifying a type of the decommissioning; identifying a pod of the pods that is hosted by the virtual machine; and performing an action set based on the type of the decommissioning to manage operation of the pod through the decommissioning of the virtual machine.

In a first instance of the type of the decommissioning that is an immediate decommissioning, the action set may include gracefully terminating operation of the pod; and preventing deployment of new pods to the virtual machine prior to the decommissioning of the virtual machine.

In a second instance of the type of the decommissioning that is a scheduled decommissioning, the action set may include preventing the deployment of the new pods to the virtual machine prior to the decommissioning of the virtual machine.

In a third instance of the type of the decommissioning that is a load balancing decommissioning, the action set may include identifying computing resources expended by the pod; making an attempt to reduce a magnitude of the computing resources expended by the pod; in an instance of the attempt where the magnitude of the computing resources expended is reduced: notifying a management entity for the virtual machine of the reduced expenditure of the computing resources to attempt to abort the decommissioning.

In the third instance of the type of the decommissioning that is a load balancing decommissioning, the action set may also include, in an instance of the notifying of the management entity where the decommissioning is not aborted: gracefully terminating operation of the pod.

Making the attempt to reduce the magnitude of the computing resources expended by the pod may include restarting a portion of the pod.

Making the attempt to reduce the magnitude of the computing resources expended by the pod may include migrating the pod to a second virtual machine.

The type of the decommissioning may be based on a management action that triggered a management entity to initiate the decommissioning. The management action may be one selected from a group of management actions consisting of: unscheduled maintenance of the data processing system; scheduled maintenance of the data processing system; and load balancing for the data processing system.

In an embodiment, a non-transitory media is provided. The non-transitory media may include instructions that when executed by a processor cause the computer implemented method to be performed.

In an embodiment, a data processing system is provided. The data processing system may include the non-transitory media and a processor, and may perform the computer implemented method when the computer instructions are executed by the processor.

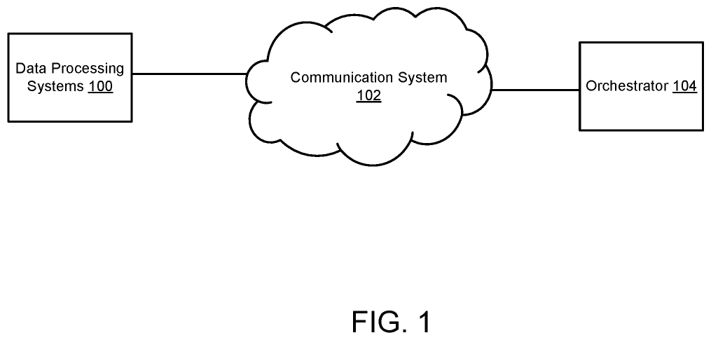

Turning to FIG. 1, a block diagram illustrating a system in accordance with an embodiment is shown. The system shown in FIG. 1 may provide computer implemented services. The computer implemented services may include any type and quantity of computer implemented services. For example, the computer implemented services may include data storage services, instant messaging services, database services, and/or any other type of service that may be implemented with a computing device.

To provide the computer implemented services, the system may include any number of data processing systems 100. Data processing systems 100 may provide the computer implemented services to users of data processing systems 100 and/or to other devices (not shown). Different data processing systems may provide similar and/or different computer implemented services.

To provide the computer implemented services, data processing systems 100 may include various hardware components (e.g., processors, memory modules, storage devices, etc.) and host various software components (e.g., operating systems, application, startup managers such as basic input-output systems, etc.). These hardware and software components may provide the computer implemented services via their operation.

The software components may be implemented using containers, and pods of containers that may share a same context (e.g., have access to shared hardware resources such as shared storage, shared network resources, etc.). The containers may include any number of applications and support services (e.g., dependencies, such as code, runtime, system libraries, etc.) for the applications. The containers may utilize a container engine or other abstraction layer for utilizing hardware resources of a host system for operation. The applications may independently and/or cooperatively provide the computer implemented services.

Any of the pods may be hosted by virtual machines. A virtual machine, in contrast to containers which may share some support services like an operating system, may time-slice or otherwise shard access to hardware resources of a host data processing system. Each virtual machine may include all of the support services necessary for application hosted by the virtual machines to operate through the provided sharded access to the hardware resources. Thus, in contrast to containers, virtual machines may duplicate more support services. A hypervisor or other type of abstraction layer may provide sharded access to the hardware resources.

In general, embodiments disclosed herein may provide methods, systems, and/or devices for providing computer implemented services using pods of containers that may be hosted by virtual machines. To provide the computer implemented services, both virtual machines and pods may be dynamically deployed and decommissioned over time as demand for use of the computer implemented services changes over time.

While deployed, the virtual machines and pods may be independently managed through various services or management layers. Any of these management layers may independently initiate decommissioning, migration, and/or other operations with respect to the pods and virtual machines.

However, if a virtual machine is decommissioned (e.g., for migration or suspension due to lack of service demand, or for other reasons) without coordinating with the pods, the operation of the pods may be disrupted. For example, a pods hosted by a virtual machine may be performing a process that may be interrupted in an unrecoverable manner by decommissioning of a virtual machine that hosts the pod.

To coordinate management of the virtual machines and the pods, the system of FIG. 1 may include orchestrator 104. Orchestrator 104 may manage the pods hosted by virtual machines in a manner that is less likely to impair the functionality of the pods. To do so, orchestrator 104 may (i) monitor for future decommissioning of virtual machines that host pods, (ii) identify the types of the decommissioning, and (iii) perform actions based on the type of the decommissioning to reduce an impact of the decommissioning on services provided, at least in part, using the impacted pods. By doing so, the operation of pods may be less likely to be impaired by proactively preparing pods for decommissioning of virtual machines.

The future decommissioning of the virtual machines may be monitored by monitoring activity of a hypervisor or other management layer that manages the operation of the virtual machines. The hypervisor may perform any number and types of processes for identifying when and for what reasons virtual machines may be decommissioned (e.g., for temporary suspension of operation for maintenance, migration for load balancing, and/or for other purposes).

The types of the decommissioning of the virtual machines may depend on the reasons for decommissioning. For example, if the reasons relate to unscheduled maintenance, then the type of the decommissioning may be urgent decommissioning. In another example, if the reasons related to scheduled maintenance, then the type of the decommissioning may be scheduled decommissioning. In a further example, if the reasons related to load balancing, then the type of the decommission may be tentative decommissioning subject to changes in load.

The actions performed based on the type of the decommissioning may attempt to mitigate impact on the pods. For example, the actions may include (i) preventing new instances of pods from being deployed to a virtual machine that is going to be decommissioned, (ii) shutting down pods hosted by the virtual machine, (iii) preventing schedule of instances of pods to be hosted by the virtual machine, (iv) reducing resource consumption by pods (e.g., through migration, restarting, migration, and/or other action) to attempt to postpone or prevent the virtual machine from being decommissioned (e.g., may trigger a hypervisor to reevaluate the workload of a host data processing system which may have trigger the decommissioning if the workload exceeded a threshold), and/or other actions that may reduce an impact of decommissioning of a virtual machine on operation of pods.

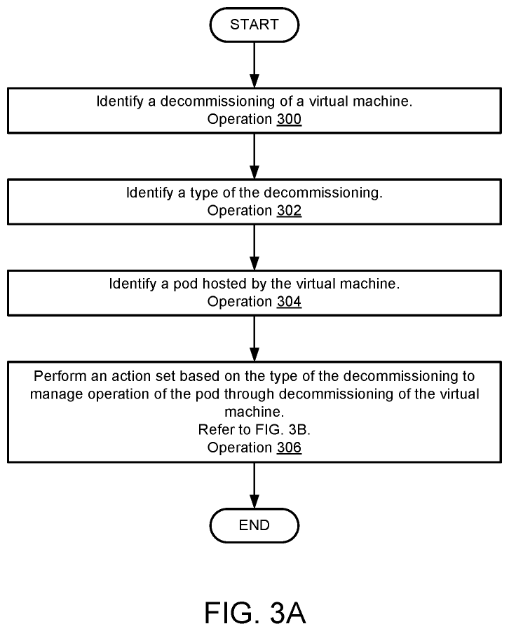

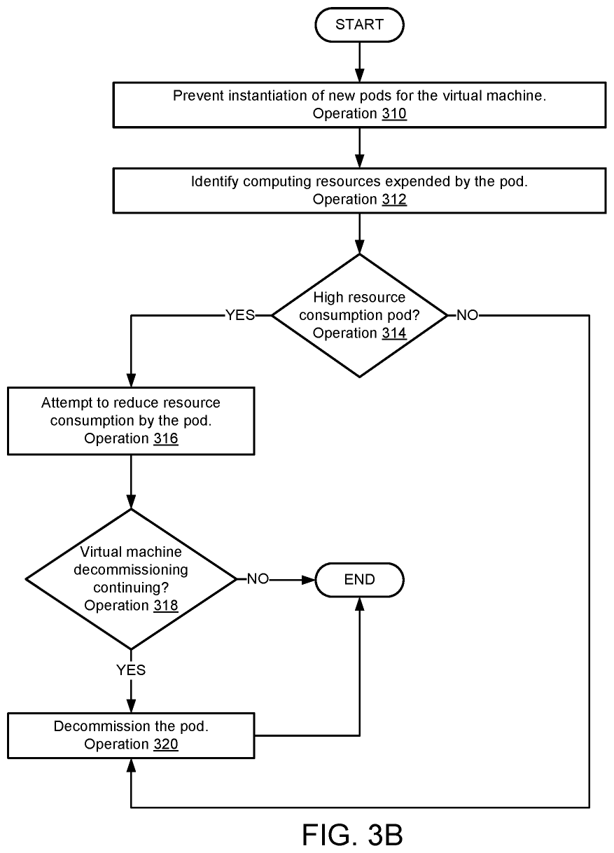

When providing its functionality, data processing systems 100 and/or orchestrator 104 may perform all, or a portion, of the method illustrated in FIG. 3.

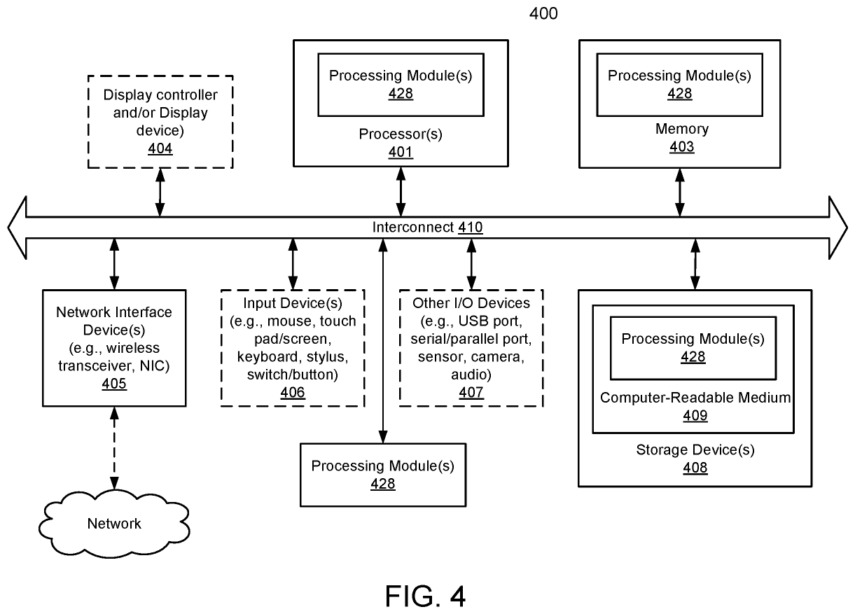

Any of data processing systems 100 and/or orchestrator 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

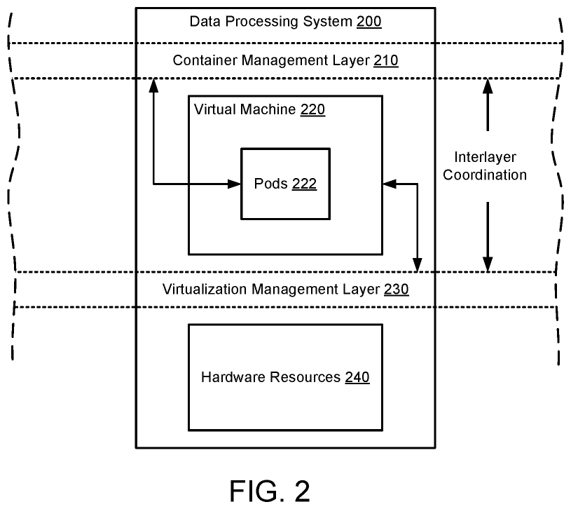

Orchestrator 104 may be implemented, in part, using an application programming interface (API). The API may facilitate communications between a hypervisor that manages virtual machines and a container management layer (e.g., 210, FIG. 2) tasked with managing containers of pods. Through the API, orchestrator 104 may automatically coordinate activity of the hypervisor and container management layer. For example, the orchestrator 104 may modify the activity of the container management layer, and provide the hypervisor with additional information usable to evaluate whether to decommission (at least temporarily) virtual machines.

While illustrated in FIG. 1 as being separate from data processing systems 100, data processing systems 100 may perform the functionality of orchestrator 104 without departing from embodiments disclosed herein. For example, rather than being implemented with a separate device, the functionality of orchestrator 104 may be implemented with a distributed service and/or API hosted by all, or a portion, of data processing systems 100.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet Protocol).

While illustrated in FIG. 1 as including a limited number of specific components, a system in accordance with an embodiment may include fewer, additional, and/or different components than those illustrated therein.

As noted above, orchestrator 104 may manage coordination between management entities that manage the operation of pods of containers and virtual machines hosted by data processing systems. Turning to FIG. 2, a data flow diagram illustrating data flows, data processing, and/or other operations that may be performed by the system of FIG. 1 in accordance with an embodiment is shown. In FIG. 2, data processing system 200 may be similar to any of data processing systems 100. Data processing system 200 may, as noted above, host an orchestration service (not shown) or agents used by orchestrator 104 to managing cooperation between management entities of data processing system 200.

To provide computer implemented services, data processing system 200 may host virtual machine 220. Virtual machine 220 may be dynamically instantiated, decommissioned, and/or otherwise managed by virtualization management layer 230 (e.g., implemented with a hypervisor and/or other management entity).

To provide the services, virtual machine may host any number of pods 222. Pods 222 may, as discussed with respect to FIG. 1, may include any number of applications and support services that provide the computer implemented services. In contrast to virtual machine 220, pods 222 may be managed by container management layer 210.

When operating, virtual machine 220, via virtualization management layer 230, may have sliced access to use of hardware resources 240. Hardware resources 240 may include, for example, processors, memory, and/or other types of hardware devices.

To facilitate management of both pods 222 and virtual machine 220 cooperatively, orchestrator 104 may facilitate interlayer coordination for decommissioning. To do so, any number of agents (not shown) for the orchestrator may be hosted by data processing system 200. Through the agents, orchestrator 104 may identify when virtual machine 220 will likely be decommissioned and the basis for being decommissioned. Consequently, through interlayer coordination, orchestrator 104 may (i) facilitate graceful shutdown or migrations of any of pods 222 prior to completion of decommissioning of virtual machine 220, (ii) attempt to modify the activity of pods 222 to reduce a need for the decommissioning, and/or (iii) limit schedule of future use of virtual machine 220 (e.g., to host other instances of pods in the future). To do so, the agents may communicate with and/or otherwise manage the operation of the management layers (e.g., 210, 230).

As discussed above, the components of FIG. 1 may perform various methods to provide computer implemented services using pods and virtual machines. FIGS. 3A-3B illustrate methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for providing computer implemented services in accordance with an embodiment is shown. The method may be performed by components of the system shown in FIG. 1, and/or other components.

At operation 300, a decommissioning of a virtual machine is identified. The decommissioning may be identified by (i) receiving a notification from a management entity indicating that the virtual machine will be decommissioned (or is scheduled for), (ii) identifying conditions that would lead to decommissioning of a virtual machine such as planned future maintenance, unscheduled maintenance, or imbalanced workloads (e.g., weighted towards a host of the virtual machine), and/or via other methods.

At operation 302, a type of the decommissioning is identified. The type of the decommissioning may be identified based on the reason for the decommissioning. The management entity that manages the virtual machine may provide the reason.

At operation 304, a container hosted by the virtual machine is identified. The identification may be made by identifying a pod that hosts the container that is hosted by the virtual machine. A management entity that manages the pods and containers may track which virtual machines host the pods and containers, and may provide the information.

At operation 306, an action set based on the type of the decommissioning to manage operation of the pod through the decommissioning of the virtual machine is performed. The action set may include action corresponding to the type of the decommissioning.

When the type of the decommissioning is an immediate decommissioning (e.g., due to unscheduled maintenance of the host data processing system), then the action set may include (i) preventing new instances of pods from being deployed to the virtual machine until after the decommissioning, and (ii) gracefully terminating operation of the pods hosted by the virtual machine, including the pod.

When the type of the decommissioning is a scheduled decommissioning (e.g., due to scheduled maintenance of the host data processing system), then the action set may include (i) preventing new instances of pods from being deployed to the virtual machine until after the decommissioning, and (ii) verifying that any currently pods hosted by the virtual machine will be decommissioned prior to decommissioning of the virtual machine.

When the type of the decommissioning is a load balancing decommissioning (e.g., due to the host data processing system being too heavily loaded), then the action set may include (i) attempting to reduce the workload on the host data processing system, and (ii) attempting to abort the decommissioning by notifying a management entity of the reduce workload on the host data processing system. If the decommissioning is not successfully aborted, the additional actions to gracefully terminate operation of the pods hosted by the virtual machine and prevent new pods from being instantiated may be performed.

In an embodiment, the action set is performed via the method illustrated in FIG. 3B. The action set may be performed via other methods without departing from embodiments disclosed herein.

The method may end following operation 306.

Turning to FIG. 3B, a second flow diagram illustrating a method for providing computer implemented services in accordance with an embodiment is shown. The method may be performed by components of the system shown in FIG. 1, and/or other components.

At operation 310, instantiation of new pods for the virtual machine may be prevented. The instantiations may be prevented by instructing a management entity that manages pods that the virtual machine is at least temporarily no longer available for hosting pods.

At operation 312, computing resources expended by the pod are identified. The computing resources may be identified by sending a request to the management entity for the pods, and receiving a response. The management entity may track historical use of computing resources by various pods.

At operation 314, a determination is made regarding whether the pod is a high resource consumption pod. The determination may be made by comparing the computing resources expended by the pod to a criteria such as a threshold. If the resources expended by the pod meet the criteria, then the pod may be determined to be a high resource consumption pod.

If the pod is a high resource consumption pod, then the method may proceed to operation 316. Otherwise, the method may proceed to operation 320 following operation 314.

At operation 316, an attempt to reduce resource consumption by the pod is made. The attempt may be made by (i) migrating the pod to a different virtual machine (e.g., hosted by a different data processing system), (ii) deallocating computing resources assigned to the pod, (iii) restarting the pod, or components of the pod such as containers or applications, and/or (iv) disabling a portion of the pod.

These attempts may reduce resource consumption by the pod. Once resource consumption is reduced, the management entity (e.g., a hypervisor) tasked with managing the virtual machine may identify that the load on the host data processing system has been reduced, thereby reducing or eliminating conditions that otherwise militate toward taking action for load balancing (e.g., such as decommissioning the virtual machine). The management entity may identify the reduce resource consumption, or orchestrator 104 may report the reduced resource consumption.

At operation 318, a determination is made regarding whether the virtual machine decommissioning is continuing. The determination may be made by receiving an indication from the management entity (e.g., hypervisor) that initiated the decommissioning of the virtual machine.

If the virtual machine decommissioning is continuing (e.g., even after the reduced resource consumption by the pod), then the method may proceed to operation 318. Otherwise, the method may end following operation 318. Ending may indicate that there is no longer a risk to the pod because the virtual machine may no longer be being decommissioned.

At operation 320, the pod is decommissioned. The pod may be gracefully decommissioned. For example, the pod may be placed into a state in which data regarding it may be stored and later used to resume operation of the pod. For example, buffers and other temporary in-memory data structures may be flushed so that an image of the pod may be established, or other types of data structure may be generated for pod operation resumption purposes.

The method may end following operation 320.

Using the methods illustrated in FIG. 3A-3B, a system in accordance with an embodiment may be able to dynamically manage both pods and virtual machines. By coordinating between the management entities that manage the pods and the virtual machines, the operation of the pods may be less likely to be impacted by decommissioning of host virtual machines.

Any of the components illustrated in FIGS. 1-2 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OSR/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer implemented services using pods hosted by virtual machines, the method comprising:
making an identification of a decommissioning of a virtual machine of the virtual machines, the virtual machine being hosted by a data processing system;
based on the identification:
identifying a type of the decommissioning;
identifying a pod of the pods that is hosted by the virtual machine; and
performing an action set based on the type of the decommissioning to manage operation of the pod through the decommissioning of the virtual machine.

2. The method of claim 1, wherein in a first instance of the type of the decommissioning that is an immediate decommissioning, the action set comprises:
gracefully terminating operation of the pod; and
preventing deployment of new pods to the virtual machine prior to the decommissioning of the virtual machine.

3. The method of claim 2, wherein in a second instance of the type of the decommissioning that is a scheduled decommissioning, the action set comprises:
preventing the deployment of the new pods to the virtual machine prior to the decommissioning of the virtual machine.

4. The method of claim 3, wherein in a third instance of the type of the decommissioning that is a load balancing decommissioning, the action set comprises:
identifying computing resources expended by the pod;
making an attempt to reduce a magnitude of the computing resources expended by the pod;
in an instance of the attempt where the magnitude of the computing resources expended is reduced:
notifying a management entity for the virtual machine of the reduced expenditure of the computing resources to attempt to abort the decommissioning.

5. The method of claim 4, wherein in the third instance of the type of the decommissioning that is a load balancing decommissioning, the action set further comprises:
in an instance of the notifying of the management entity where the decommissioning is not aborted:
gracefully terminating operation of the pod.

6. The method of claim 5, wherein making the attempt to reduce the magnitude of the computing resources expended by the pod comprises:
restarting a portion of the pod.

7. The method of claim 5, wherein making the attempt to reduce the magnitude of the computing resources expended by the pod comprises:
migrating the pod to a second virtual machine.

8. The method of claim 1, wherein the type of the decommissioning is based on a management action that triggered a management entity to initiate the decommissioning.

9. The method of claim 8, wherein the management action is one selected from a group of management actions consisting of:
unscheduled maintenance of the data processing system;
scheduled maintenance of the data processing system; and
load balancing for the data processing system.

10. A non-transitory machine-readable medium having instructions stored therein, which when executed by a processor, cause the processor to perform operations for providing implemented services using pods hosted by virtual machines, the operations comprising:
making an identification of a decommissioning of a virtual machine of the virtual machines, the virtual machine being hosted by a data processing system;
based on the identification:
identifying a type of the decommissioning;
identifying a pod of the pods that is hosted by the virtual machine; and
performing an action set based on the type of the decommissioning to manage operation of the pod through the decommissioning of the virtual machine.

11. The non-transitory machine-readable medium of claim 10, wherein in a first instance of the type of the decommissioning that is an immediate decommissioning, the action set comprises:
gracefully terminating operation of the pod; and
preventing deployment of new pods to the virtual machine prior to the decommissioning of the virtual machine.

12. The non-transitory machine-readable medium of claim 11, wherein in a second instance of the type of the decommissioning that is a scheduled decommissioning, the action set comprises:
preventing the deployment of the new pods to the virtual machine prior to the decommissioning of the virtual machine.

13. The non-transitory machine-readable medium of claim 12, wherein in a third instance of the type of the decommissioning that is a load balancing decommissioning, the action set comprises:
identifying computing resources expended by the pod;
making an attempt to reduce a magnitude of the computing resources expended by the pod;
in an instance of the attempt where the magnitude of the computing resources expended is reduced:
notifying a management entity for the virtual machine of the reduced expenditure of the computing resources to attempt to abort the decommissioning.

14. The non-transitory machine-readable medium of claim 13, wherein in the third instance of the type of the decommissioning that is a load balancing decommissioning, the action set further comprises:
in an instance of the notifying of the management entity where the decommissioning is not aborted:
gracefully terminating operation of the pod.

15. The non-transitory machine-readable medium of claim 14, wherein making the attempt to reduce the magnitude of the computing resources expended by the pod comprises:
restarting a portion of the pod.

16. The non-transitory machine-readable medium of claim 14, wherein making the attempt to reduce the magnitude of the computing resources expended by the pod comprises:
migrating the pod to a second virtual machine.

17. The non-transitory machine-readable medium of claim 10, wherein the type of the decommissioning is based on a management action that triggered a management entity to initiate the decommissioning.

18. The non-transitory machine-readable medium of claim 17, wherein the management action is one selected from a group of management actions consisting of:
unscheduled maintenance of the data processing system;
scheduled maintenance of the data processing system; and
load balancing for the data processing system.

19. A data processing system, comprising:
a processor; and
a memory coupled to the processor to store instructions, which when executed by the processor, cause the processor to perform operations for providing computer implemented services using pods of containers, the operations comprising:
making an identification of a decommissioning of a virtual machine of the virtual machines, the virtual machine being hosted by a host data processing system;
based on the identification:
identifying a type of the decommissioning;
identifying a pod of the pods that is hosted by the virtual machine; and
performing an action set based on the type of the decommissioning to manage operation of the pod through the decommissioning of the virtual machine.

20. The data processing system of claim 19, wherein the type of the decommissioning is based on a management action that triggered a management entity to initiate the decommissioning, and the management action is one selected from a group of management actions consisting of:
unscheduled maintenance of the host data processing system;
scheduled maintenance of the host data processing system; and
load balancing for the host data processing system.
